(19) United States
(12) Patent Application Publication
(10) Pub. No.: US 2019/0258843 A1
(43) Pub. Date: Aug. 22, 2019

(54) ELECTRONIC DEVICE AND CONTROL METHOD

(71) Applicant: KYOCERA CORPORATION, Kyoto (JP)

(72) Inventors: Isao MASUIKE, Tokyo (JP); Yasuhiro UENO, Yokohama-shi (JP); Shigeki TANABE, Yokohama-shi (JP); Hideki MORITA, Yokohama-shi (JP); Koutaro YAMAUCHI, Yokohama-shi (JP); Manabu SAKUMA, Yokohama-shi (JP); Kenji SHIMADA, Yokohama-shi (JP)

(21) Appl. No.: 16/275,204

(22) Filed: Feb. 13, 2019

(30) Foreign Application Priority Data
Feb. 19, 2018 (JP) 2018-026784

(51) Int. Cl. G06K 9/00; G06F 3/03; G06F 3/041; G06F 1/16

(52) U.S. Cl. CPC G06K 9/00013; G06K 9/00087; G06K 2009/0006; G06F 3/0412; G06F 1/1643; G06F 3/0304

(57) ABSTRACT

An electronic device and a control method are disclosed. In one embodiment, an electronic device comprises a case, a display, a fingerprint authentication area, and a light emitter. The display is located on at least one surface of the case. The fingerprint authentication area is located on a surface of the display. The light emitter is located inside the case. The fingerprint authentication area comprises an area through which light of the light emitter is visibly recognizable.

### CROSS-REFERENCE TO RELATED APPLICATION

The present application claims priority under 35 U.S.C. § 119 to Japanese Patent Application No. 2018-026784, filed on Feb. 19, 2018, entitled “ELECTRONIC DEVICE AND CONTROL METHOD”. The content of which is incorporated by reference herein in its entirety.

### FIELD

Embodiments of the present disclosure relate generally to an electronic device and a control method.

### BACKGROUND

Various technologies have been proposed for an electronic device.

### SUMMARY

An electronic device and a control method are disclosed. In one embodiment, an electronic device comprises a case, a display, a fingerprint authentication area, and a light emitter. The display is located on at least one surface of the case. The fingerprint authentication area is located on a surface of the display. The light emitter is located inside the case. The fingerprint authentication area comprises an area through which light of the light emitter is visibly recognizable.

In one embodiment, an electronic device comprises a case, a display, a fingerprint authentication area, a light emitter, and a light guiding unit. The display is located on at least one surface of the case. The fingerprint authentication area is located on a surface of the display. The light emitter is located inside the case. The light guiding unit is located inside the case. The light guiding unit guides light of the light emitter such that the light passes through a vicinity of the fingerprint authentication area.

In one embodiment, a control method is a control method for an electronic device. The electronic device comprises a case, a display, a fingerprint sensor, a light emitter, and at least one processor. The display is located on at least one surface of the case. The fingerprint sensor comprises a fingerprint authentication area located on a surface of the display. The light emitter is located inside the case. The fingerprint authentication area comprises an area through which light of the light emitter is visibly recognizable. The control method comprises determining whether fingerprint authentication of the fingerprint sensor is possible by using the at least one processor, and making the light emitter emit light when it is determined that the fingerprint authentication is possible.

In one embodiment, a control method is a control method for an electronic device. The electronic device comprises a case, a display, a fingerprint sensor, a light emitter, at least one processor, and a light guiding unit. The display is located on at least one surface of the case. The fingerprint sensor comprises a fingerprint authentication area located on a surface of the display. The light emitter is located inside the case. The light guiding unit is located inside the case. The light guiding unit guides light of the light emitter such that the light passes through a vicinity of the fingerprint authentication area. The control method comprises determining whether fingerprint authentication of the fingerprint sensor is possible by using the at least one processor, and making the light emitter emit light when it is determined that the fingerprint authentication is possible.

### BRIEF DESCRIPTION OF THE DRAWINGS

FIG. 1 illustrates a perspective view showing one example of external appearance of an electronic device.

FIG. 2 illustrates a back view showing one example of external appearance of the electronic device.

FIG. 3 illustrates a block diagram showing one example of a configuration of the electronic device.

FIG. 4 illustrates a schematic cross-sectional view showing one example of a cross-section of the electronic device taken along the line A-A′ illustrated in FIG. 1.

FIG. 5 illustrates a diagram showing one example of display of the electronic device.

FIG. 6 illustrates a schematic cross-sectional view showing another example of a cross-section of the electronic device taken along the line A-A′ illustrated in FIG. 1.

FIG. 7 illustrates a schematic cross-sectional view showing another example of a cross-section of the electronic device taken along the line A-A′ illustrated in FIG. 1.

FIG. 8 illustrates a diagram showing one example of display of the electronic device.

FIG. 9 illustrates a schematic cross-sectional view showing another example of a cross-section of the electronic device taken along the line A-A′ illustrated in FIG. 1.

FIG. 10 illustrates a diagram showing one example of display of the electronic device.

FIG. 11 illustrates a flowchart showing one example of operation of the electronic device.

FIG. 12 illustrates a flowchart showing one example of operation of the electronic device.

FIG. 13 illustrates a flowchart showing one example of operation of the electronic device.

### DETAILED DESCRIPTION

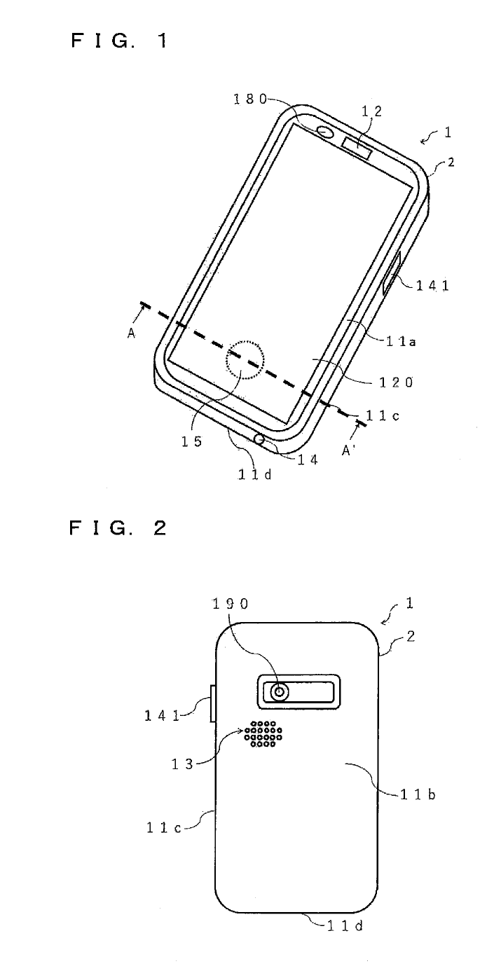

FIG. 1 and FIG. 2 respectively illustrate a perspective view and a back view showing one example of external appearance of an electronic device 1.

On a front surface 11a of a case 2 of the electronic device 1, a display 120 on which various pieces of information such as letters, symbols, and graphics are displayed is disposed. A touch sensor 131 is located on a back surface side of the display 120. A user can input various pieces of information into the electronic device 1 by operating the display 120 on the front surface of the electronic device 1 with a finger or the like. Note that the user can input various pieces of information into the electronic device 1 by operating the display 120 with a pointer other than a finger, namely, a touch panel pen such as a stylus pen. The electronic device 1 can scan fingerprint information in a fingerprint authentication area 15 that is located on a display surface of the display 120.

A receiver hole 12 is located at an upper end portion of the front surface 11a of the case 2. A microphone hole 14 is located on a side surface 11d on a lower side of the case 2. A lens of a first camera 180 is visibly recognizable from the upper end portion of the front surface 11a of the case 2. As illustrated in FIG. 2, a lens of a second camera 190 is visibly recognizable from an upper end portion of a back surface 11b of the electronic device 1, that is, a back surface of the case 2. Further, a speaker hole 13 is located on the back surface 11b of the case 2.

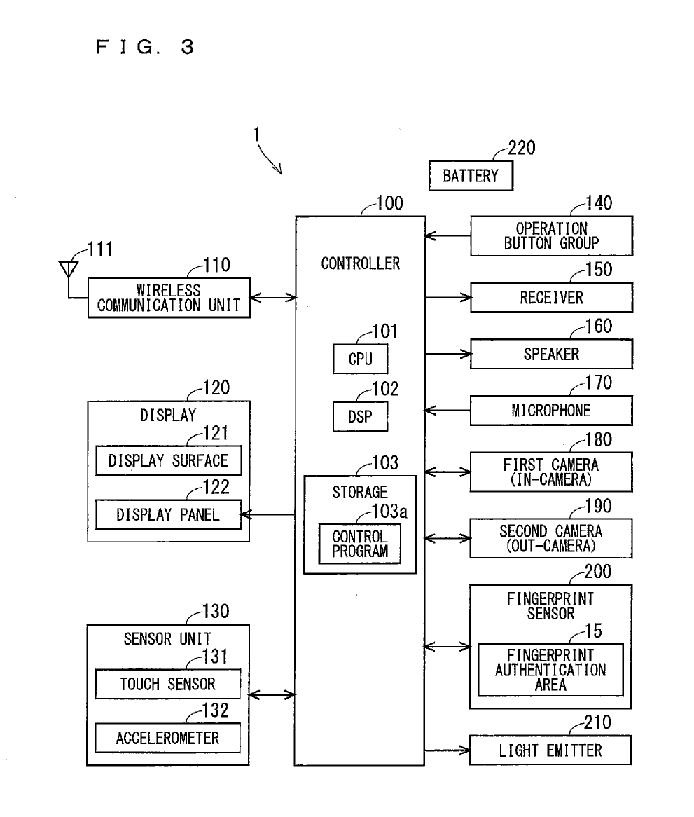

FIG. 3 illustrates a block diagram mainly showing one example of an electrical configuration of the electronic device 1. As illustrated in FIG. 3, the electronic device 1 comprises a controller 100, a wireless communication unit 110, a display 120, a touch sensor 131, an accelerometer 132, and an operation button group 140. The electronic device 1 further comprises a receiver 150, a speaker 160, a microphone 170, a first camera 180, a second camera 190, a fingerprint sensor 200, a light emitter 210, and a battery 220.

The controller 100 can integrally manage operation of the electronic device 1 by controlling other components of the electronic device 1. It can also be said that the controller 100 is a control device or a control circuit. The controller 100 comprises at least one processor for providing control and processing capability to perform various functions as described in further detail below.

In accordance with various embodiments, the at least one processor may be implemented as a single integrated circuit (IC) or as multiple communicatively coupled integrated circuits (IC's) and/or discrete circuits. It is appreciated that the at least one processor can be implemented in accordance with various known technologies.

In one embodiment, the processor comprises one or more circuits or units configurable to perform one or more data computing procedures or processes by executing instructions stored in an associated memory, for example. In other embodiments, the processor may be implemented as firmware configured to perform one or more data computing procedures or processes. The firmware is, for example, discrete logic components.

In accordance with various embodiments, the processor may comprise one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described herein.

In one embodiment, the controller 100 comprises a central processing unit (CPU) 101, a digital signal processor (DSP) 102, and a storage 103. The storage 103 comprises a non-transitory recording medium that can be read by the CPU 101 and the DSP 102, such as a read only memory (ROM) and a random access memory (RAM).

The ROM of the storage 103 is, for example, a flash ROM (flash memory) that is non-volatile memory. The storage 103 stores a plurality of control programs 103a etc. for controlling the electronic device 1. Various functions of the controller 100 are implemented by the CPU 101 and the DSP 102 executing the various control programs 103a in the storage 103.

Note that the controller 100 may comprise a plurality of CPUs 101. In this case, the controller 100 may comprise a main CPU having high processing capability that performs relatively complex processing, and a sub-CPU having low processing capability that performs relatively simple processing. Further, the controller 100 may omit the DSP 102, or may comprise a plurality of DSPs 102. Further, all of the functions of the controller 100 or a part of the functions of the controller 100 may be implemented by a hardware circuit that does not require software to implement the functions of the hardware circuit.

The storage 103 may comprise a non-transitory recording medium that can be read by a computer, other than the ROM and the RAM. The storage 103 may comprise, for example, a small-sized hard disk drive and a solid state drive (SSD).

The plurality of control programs 103a in the storage 103 comprise various applications (i.e., application programs). The storage 103 stores, for example, a phone application for making a voice call and a video call, and an email application for creating, viewing, sending, and receiving electronic mail. The storage 103 further stores a camera application for capturing an image of an object using the first camera 180 and the second camera 190, an image application for displaying still images stored in the storage 103, etc. The storage 103 stores fingerprint information that is pre-registered in the electronic device 1 by the user. At least one application in the storage 103 may be an application stored in the storage 103 in advance. Further, at least one application in the storage 103 may be an application downloaded from another device by the electronic device 1 and is stored in the storage 103.

The wireless communication unit 110 comprises an antenna 111. The wireless communication unit 110 can, for example, wirelessly communicate in a plurality of types of communication modes using the antenna 111. The wireless communication of the wireless communication unit 110 is controlled by the controller 100.

The wireless communication unit 110 can wirelessly communicate with a base station of a mobile phone system. The wireless communication unit 110 can communicate with a mobile phone device different from the electronic device 1, a web server, or the like via a network of the base station, the Internet, etc. The electronic device 1 can perform data communication, a voice call, a video call, etc. with another mobile phone device or the like.

Further, wireless communication can be performed using the wireless communication unit 110 and a wireless local area network (LAN) such as WiFi. Further, the wireless communication unit 110 can perform short-range wireless communication. For example, the wireless communication unit 110 can wirelessly communicate in conformity to Bluetooth (trademark). The wireless communication unit 110 may be able to wirelessly communicate in conformity to at least one of ZigBee (trademark) and near field communication (NFC).

The wireless communication unit 110 subjects an incoming signal received at the antenna 111 to various types of processing such as amplification processing, and then outputs the processed signal to the controller 100. The controller 100 subjects an incoming signal to various types of processing to acquire information contained in the incoming signal. Further, the controller 100 outputs a signal containing information to the wireless communication unit 110. The wireless communication unit 110 subjects an incoming signal to various types of processing such as amplification processing, and then wirelessly transmits the processed signal from the antenna 111.

The display 120 comprises a display surface 121 located on the front surface 11a of the electronic device 1, and a display panel 122. The display 120 can display various pieces of information on the display surface 121. The display panel 122 is opposed to the display surface 121 in the electronic device 1. Information displayed on the display 120 is displayed on the display surface 121 on the surface of the electronic device 1. The display panel 122 can display various pieces of information.

Note that the display panel 122 may be, for example, a light-emitting display panel such as an organic electroluminescent (EL) panel, or an inorganic electroluminescent (EL) panel.

The display panel 122 is formed such that light passes through the back surface that is located on the opposite side of the display surface 121 toward the display surface 121. For example, if a display panel such as an organic electroluminescent (EL) panel or an inorganic electroluminescent (EL) panel is used, a substrate and an electrode used in the display panel 122 are made of a light-transmitting material. Note that, it is sufficient that the display panel 122 be formed such that light passes through a surface located on the opposite side of the display surface 121 toward the display surface 121 in at least a part of the display panel 122 that corresponds to the fingerprint authentication area 15.

The electronic device 1 comprises the touch sensor 131 and the accelerometer 132 as a sensor unit 130.

The touch sensor 131 can detect operation performed on the display 120 by a pointer such as a finger. It can also be said that the touch sensor 131 is a sensor that detects operation performed on the display 120. The touch sensor 131 is, for example, a projected capacitive touch sensor. The touch sensor 131 is, for example, located on the back of the display 120. When the user performs operation on the display 120 with a pointer such as a finger, the touch sensor 131 can input an electrical signal corresponding to the operation into the controller 100. The controller 100 can specify the details of the operation performed on the display 120 based on the electrical signal (output signal) from the touch sensor 131. Then, the controller 100 can perform processing depending on the specified details of the operation. Note that, in place of the display panel 122 and the touch sensor 131, an in-cell display panel with a built-in touch sensor may be adopted.

The accelerometer 132 detects a direction and magnitude of acceleration acting on the electronic device 1. The accelerometer 132 converts information of detected acceleration into an output signal. The accelerometer 132 is, for example, of a three-axis (three dimensional) type that detects acceleration in an x-axis direction, a y-axis direction, and a z-axis direction. The accelerometer 132 may be, for example, of a piezoresistive type, or an electrostatic capacitance type.

Note that the electronic device 1 may comprise a sensor other than the touch sensor 131 and the accelerometer 132 as the sensor unit 130. For example, the electronic device 1 may comprise at least one of an air-pressure sensor, a geomagnetic sensor, a temperature sensor, a proximity sensor, an illuminance sensor, and a gyro sensor.

When operated by the user, each operation button of the operation button group 140 can output to the controller 100 an operation signal indicating that the button has been operated. Concerning each operation button, the controller 100 can determine whether or not the operation button has been operated. When the controller 100 that has received the operation signal controls other components, a function allocated to the operated operation button is implemented in the electronic device 1.

The microphone 170 can convert sound input from the outside of the electronic device 1 into an electrical sound signal, and can output the converted signal to the controller 100. Sound from the outside of the electronic device 1 is taken into the electronic device 1 through the microphone hole 14, and is then input to the microphone 170.

The speaker 160 is, for example, a dynamic speaker. The speaker 160 can convert an electrical sound signal from the controller 100 into sound, and can output the converted sound. The sound output from the speaker 160 is output to the outside through the speaker hole 13. The user can hear the sound output from the speaker hole 13 even at a place away from the electronic device 1.

The receiver 150 can output received voice sound. The receiver 150 is, for example, a dynamic speaker. The receiver 150 can convert an electrical sound signal from the controller 100 into sound, and can output the converted sound. The sound output from the receiver 150 is output to the outside through the receiver hole 12. The volume of the sound output through the receiver hole 12 is smaller than the volume of the sound output through the speaker hole 13. The user brings his/her ear closer to the receiver hole 12 to hear the sound output through the receiver hole 12. Note that, in place of the receiver 150, a vibration element such as a piezoelectric vibration element that vibrates a front surface portion of the electronic device 1 may be provided. In this case, sound is conveyed to the user through the vibration of the front surface portion.

The first camera 180 comprises a lens, an image sensor, etc. The second camera 190 comprises a lens, an image sensor, etc. Each of the first camera 180 and the second camera 190 can capture an image of an object in accordance with the control of the controller 100, can produce a still image or a moving image depicting the captured object, and can output the image to the controller 100.

The lens of the first camera 180 is visibly recognizable from the front surface 11a of the electronic device 1. Therefore, the first camera 180 can capture an image of an object present at the front surface side (i.e., the display 120 side) of the electronic device 1. The first camera 180 is referred to as an in-camera. Meanwhile, the lens of the second camera 190 is visibly recognizable from the back surface 11b of the electronic device 1. Therefore, the second camera 190 can capture an image of an object present at the back surface side of the electronic device 1. The second camera 190 is referred to as an out-camera.

The electronic device 1 comprises the operation button group 140 that is made up of a plurality of operation buttons. Each of the operation buttons is, for example, a hardware button, and is located on the surface of the electronic device 1. Each of the operation buttons is, for example, a push button. The operation button group 140 comprises a power button 141. The power button 141 is located on a side surface 11c of the electronic device 1.

The operation button group 140 comprises an operation button other than the power button 141. For example, the operation button group 140 comprises a volume button.

The fingerprint sensor 200 can scan fingerprint information in the fingerprint authentication area 15. The fingerprint authentication area 15 is located on the display surface 121 of the display 120.

A fingerprint detecting method of the fingerprint sensor 200 is, for example, an electrostatic capacitance method. The electrostatic capacitance between the fingerprint sensor 200 and a finger varies depending on the ridges and valleys formed in a fingerprint of the finger. Therefore, the fingerprint sensor 200 can scan fingerprint information of the finger by detecting electrostatic capacitance between the fingerprint sensor 200 and the finger. Further, if the fingerprint sensor 200 employs the electrostatic capacitance method, the electronic device 1 may use the touch sensor 131 of the electrostatic capacitance method as the fingerprint sensor 200.

Further, the fingerprint detecting method of the fingerprint sensor 200 may be, for example, a method other than the electrostatic capacitance method. For example, the fingerprint detecting method of the fingerprint sensor 200 may be an optical method.

The battery 220 can output power of the electronic device 1. The battery 220 is, for example, a rechargeable battery. The power output from the battery 220 is supplied to various components of the electronic device 1, such as the controller 100 and the wireless communication unit 110.

The light emitter 210 is a light emitting element. As the light emitting element, a light emitting diode (LED), organic electro-luminescence (Organic EL), inorganic electro-luminescence (Inorganic EL), or the like is used. The light emitter 210 can switchably turn on and off the light, and can emit predetermined light. Note that the light emitter 210 can emit various wavelengths, i.e., light of various colors.

The electronic device 1 comprises a number of operation modes. Examples of the operation modes of the electronic device 1 include a normal mode, a sleep mode, and a shutdown mode. During the shutdown mode, the electronic device 1 is shut down, and most of the functions of the electronic device 1 are stopped. During the sleep mode, some of the functions of the electronic device 1, including a display function, are stopped. The normal mode refers to a state in which the electronic device 1 operates in a mode other than the sleep mode and the shutdown mode. The controller 100 controls predetermined components of the electronic device 1 in accordance with an operation mode to be set, thereby setting the operation mode of the electronic device 1.

During the sleep mode, for example, some components of the electronic device 1, including the display panel 122, the touch sensor 131, the first camera 180, the second camera 190, etc., do not operate. During the shutdown mode, most of the components of the electronic device 1, including the display panel 122, the touch sensor 131, the first camera 180, the second camera 190, etc., do not operate. Power consumption of the electronic device 1 is further reduced in the sleep mode than power consumption in the normal mode. Power consumption of the electronic device 1 is further reduced in the shutdown mode than power consumption in the sleep mode.

Further, the display 120 enters a non-display state during the sleep mode and the shutdown mode. A display state refers to a state in which the electronic device 1 intentionally performs display on the display 120. Further, the non-display state refers to a state in which the electronic device 1 does not intentionally perform display on the display 120. Further, if the display panel 122 is a light-emitting display panel such as an organic EL panel, the display 120 enters the non-display state when all of the pixels do not emit light. Specifically, the display 120 enters the non-display state when the entire area of the display area in the display panel 122 is turned off.

When the power button 141 is pressed for a long period of time during the normal mode, the display 120 displays a confirmation screen for confirming with the user whether or not the mode should be transitioned from the normal mode to the shutdown mode. When the user performs predetermined operation on the display 120 while the display 120 displays the confirmation screen, the mode is transitioned from the normal mode to the shutdown mode.

Further, when no operation is performed on the electronic device 1 for a certain period of time or more during the normal mode, the mode is transitioned from the normal mode to the sleep mode. Further, when the power button 141 is pressed for a short period of time during the normal mode, the mode is transitioned from the normal mode to the sleep mode.

On the other hand, when the power button 141 is pressed for a short period of time during the sleep mode, the mode is transitioned from the sleep mode to the normal mode. Specifically, when the power button 141 is pressed for a short period of time during the sleep mode, functions stopped when the mode was transitioned into the sleep mode are restored in the electronic device 1. In one embodiment, the normal mode comprises a lock mode. When the power button 141 is pressed for a short period of time during the sleep mode, the mode is transitioned from the sleep mode to the lock mode. Further, when predetermined operation is performed on the fingerprint authentication area 15 during the sleep mode, the mode is transitioned from the sleep mode to the normal mode.

Note that, even if particular description is not given, the normal mode comprises operation modes of the electronic device 1 described below other than the shutdown mode and the sleep mode. Further, the term “operation mode” itself refers to an operation mode of the electronic device 1. Further, operation in which a surface of the electronic device 1 is pressed for a short period of time without changing the pressing position, i.e., operation in which a surface of the electronic device 1 is pressed for less than a first predetermined period of time without changing the pressing position, is referred to as “short-pressing operation.” Further, operation in which a surface of the electronic device 1 is pressed for a long period of time without changing the pressing position, i.e., operation in which a surface of the electronic device 1 is pressed for a second predetermined period of time (the first predetermined period of time) or more without changing the pressing position, may be referred to as “long-pressing operation.”

The display 120 displays various screens during the normal mode. It can also be said that a screen displayed on the display 120 is an image displayed on the display 120.

The normal mode comprises the lock mode, where the user cannot make the electronic device 1 execute applications other than certain applications among the plurality of applications in the storage 103. Examples of the certain applications include a phone application and a camera application. The lock mode is also referred to as a screen lock mode. During the lock mode, the user cannot instruct the electronic device 1 to execute the applications other than the certain applications among the plurality of applications in the storage 103. The electronic device 1 can display the lock screen on the display 120 during the lock mode. The lock screen is a screen to give notice that the electronic device 1 is in a lock mode. Note that the lock mode is a mode in which the user cannot execute some or all of the applications in the storage 103. When the user performs predetermined operation on the electronic device 1 while the display 120 displays the lock screen, the lock mode is disabled in the electronic device 1, and the display on the display 120 is transitioned from the lock screen into another screen such as a home screen. The state in which the lock mode is disabled during the normal mode may be hereinafter referred to as an “unlocked mode.”

The controller 100 can perform fingerprint authentication based on fingerprint information scanned by the fingerprint sensor 200. Given below is the description of one example of the fingerprint authentication.

In performing fingerprint authentication, the controller 100 produces a fingerprint image that represents fingerprint information scanned by the fingerprint sensor 200 based on an output signal from the fingerprint sensor 200. Then, the controller 100 extracts feature points that represent features of the scanned fingerprint information from the produced fingerprint image. As the feature points, the positions of an ending point and a bifurcation point of a ridge (raised portion), the thickness of a ridge, etc. of the fingerprint are used, for example. Then, the controller 100 compares the extracted feature points and reference feature points stored in the storage 103. The reference feature points are feature points extracted from a fingerprint image representing fingerprint information of an authorized user. The authorized user is, for example, the owner of the electronic device 1. If the extracted feature points and the reference feature points are similar to each other as a result of the comparison between both the feature points, the controller 100 determines that the fingerprint authentication has succeeded. The fingerprint authentication may be regarded as one type of user authentication. Therefore, it can be said that the controller 100 determines that the user who has the fingerprint information scanned by the fingerprint sensor 200 is the authorized user if the extracted feature points and the reference feature points are similar to each other. On the other hand, if the extracted feature points and the reference feature points are not similar to each other, the controller 100 determines that the fingerprint authentication has failed. Specifically, the controller 100 determines that the user who has the fingerprint information scanned by the fingerprint sensor 200 is an unauthorized user.

The electronic device 1 may comprise a fingerprint registration mode for registering fingerprint information of the user. In the electronic device 1, when the authorized user places a finger (the pad of the finger, to be specific) of his/her hand on the fingerprint authentication area 15 during a fingerprint registration mode, the fingerprint sensor 200 scans fingerprint information of the finger. The controller 100 produces a fingerprint image that represents fingerprint information scanned by the fingerprint sensor 200 based on an output signal from the fingerprint sensor 200. Then, the controller 100 extracts feature points from the produced fingerprint image, and stores the extracted feature points in the storage 103 as reference feature points. The reference feature points representing the features of the fingerprint of the authorized user are stored in the storage 103. Specifically, the fingerprint information of the authorized user is registered in the electronic device 1. Fingerprint information that is pre-registered in the electronic device 1 as described above is referred to as registered fingerprint information.

Note that the storage 103 in some cases stores a plurality of sets of reference feature points. In such cases, the controller 100 compares extracted feature points with each of the plurality of sets of reference feature points stored in the storage 103. The controller 100 determines that the fingerprint authentication has succeeded if the plurality of sets of reference feature points contain a set of reference feature points that is similar to the extracted feature points. On the other hand, the controller 100 determines that the fingerprint authentication has failed if the plurality of sets of reference feature points do not contain a set of reference feature points that is similar to the extracted feature points.

In one embodiment, the electronic device 1 comprises a case 2, a display 120 located on at least one surface of the case 2, a fingerprint authentication area 15 located on a surface of the display 120, and a light emitter 210 located inside the case 2. The fingerprint authentication area 15 comprises an area 212 through which light 211 of the light emitter 210 is visibly recognizable.

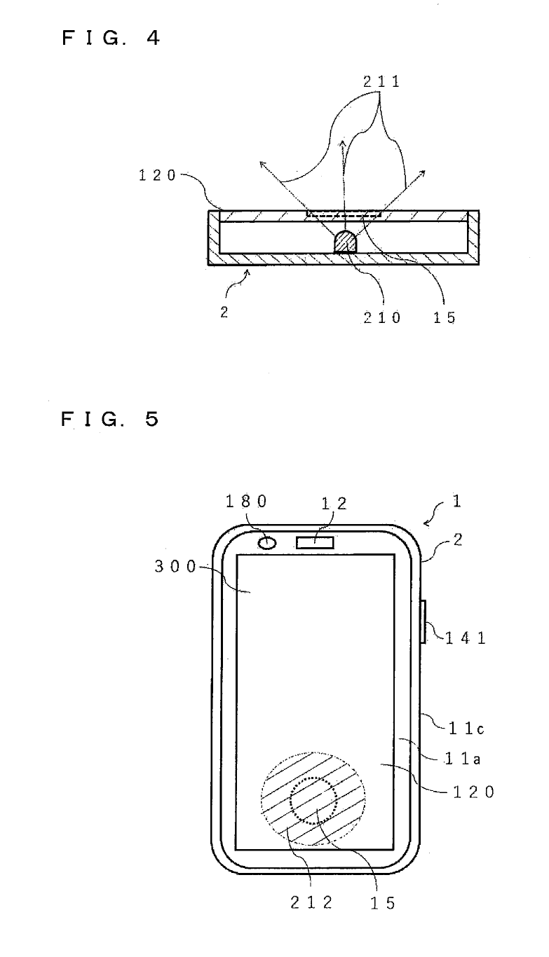

FIG. 4 illustrates a schematic cross-sectional view showing one example of a cross-section of the electronic device 1 taken along the line A-A′ illustrated in FIG. 1.

The light emitter 210 of the electronic device 1 is located inside the case 2. The electronic device 1 determines whether the fingerprint sensor 200 can perform fingerprint authentication. If the electronic device 1 determines that the fingerprint sensor 200 can perform fingerprint authentication, the electronic device 1 makes the light emitter 210 emit light. The state in which the fingerprint sensor 200 can perform fingerprint authentication means a state in which the fingerprint sensor 200 can scan fingerprint information when a finger comes into contact with the fingerprint authentication area 15. Conceivable specific examples include a case where power is supplied to the fingerprint sensor 200, and a case where a fingerprint sensor 200 configured to be switchably turned on and off is set to be turned on. Light emitted by the light emitter 210 passes through at least a part of the fingerprint authentication area 15 of the display 120. Note that the position, the shape, etc. of the light emitter 210 may be changed as appropriate as long as the light emitter 210 makes light emitted by the light emitter 210 pass through at least a part of the fingerprint authentication area 15 of the display 120.

As illustrated in FIG. 5, in the electronic device 1 illustrated in FIG. 4, the area 212 through which light of the light emitter 210 is visibly recognizable can be formed at the fingerprint authentication area 15 of the display 120 and around the fingerprint authentication area 15. The user can estimate the position of the fingerprint authentication area 15 with the aid of the area 212 through which light of the light emitter 210 is visibly recognizable.

In one embodiment, the electronic device 1 comprises a light guiding unit 17 that is located inside the case 2. The light guiding unit 17 guides light 211 of the light emitter 210 such that the light 211 passes through the fingerprint authentication area 15.

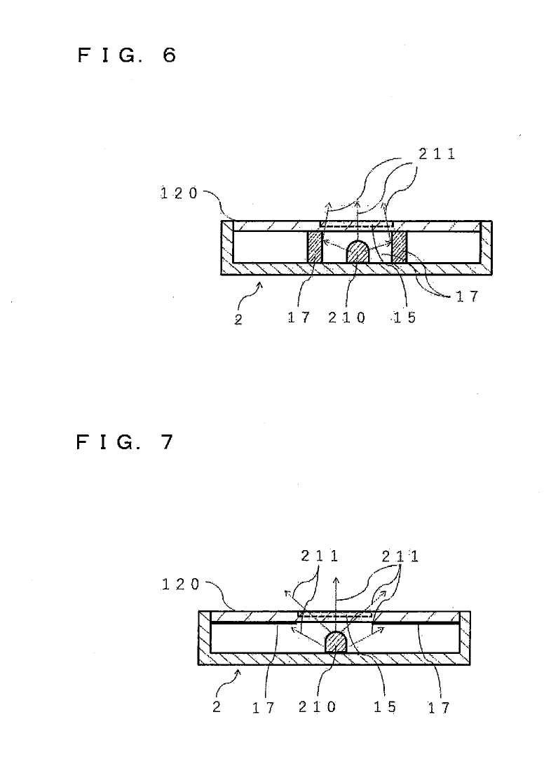

FIG. 6 illustrates a schematic cross-sectional view showing another example of a cross-section of the electronic device 1 taken along the line A-A′ illustrated in FIG. 1.

The electronic device 1 comprises the light guiding unit 17 that is located inside the case 2. The light guiding unit 17 may be provided to surround the periphery of the light emitter 210. The light guiding unit 17 guides light emitted by the light emitter 210 such that the light passes through at least a part of the fingerprint authentication area 15. The light guiding unit 17 may be made of a material such as resin, metal, or ceramics. Note that, as the material used for the light guiding unit 17, a material through which light emitted by the light emitter 210 does not easily pass may be selected. The light guiding unit 17 can also be alternatively referred to as a light blocking unit. For example, the light guiding unit may be a light blocking sheet. A wall surface of the light guiding unit 17 on the light emitter 210 side may be a mirror surface. If the wall surface of the light guiding unit 17 is a mirror surface, more light of the light emitter 210 can pass through the fingerprint authentication area 15. Note that the position, the shape, etc. of the light guiding unit 17 may be changed as appropriate as long as the light guiding unit 17 makes light emitted by the light emitter 210 converge toward the fingerprint authentication area 15.

FIG. 7 illustrates a schematic cross-sectional view showing another example of a cross-section of the electronic device 1 taken along the line A-A′ illustrated in FIG. 1.

The light guiding unit 17 may be located on a surface on the opposite side of the display surface 121. The light guiding unit 17 is not provided at a position on the back of the fingerprint authentication area 15 in order that light of the light emitter 210 passes through the fingerprint authentication area 15. The light guiding unit 17 guides light of the light emitter 210 such that the light passes through at least a part of the fingerprint authentication area 15. Note that, as the material used for the light guiding unit 17, a material through which light emitted by the light emitter 210 does not easily pass may be selected. The light guiding unit 17 is fixed to a surface on the opposite side of the display surface 121 by an adhesive agent or the like. A wall surface of the light guiding unit 17 on the light emitter 210 side may be a mirror surface.

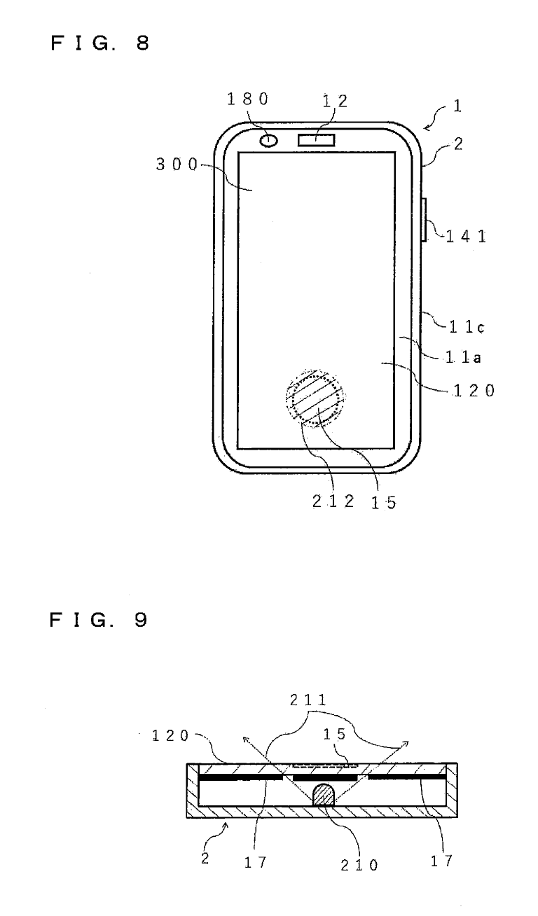

As illustrated in FIG. 8, in the electronic device 1 illustrated in FIG. 6 and FIG. 7, the area 212 through which light of the light emitter 210 is visibly recognizable can be formed at the fingerprint authentication area 15. In the electronic device 1, the light guiding unit 17 makes light of the light emitter 210 converge toward the fingerprint authentication area 15. Therefore, luminance of the area 212 through which light of the light emitter 210 is visibly recognizable is higher than luminance of the case without the light guiding unit 17. Specifically, the user of the electronic device 1 can easily locate the fingerprint authentication area 15.

The size and the shape of the area 212 through which light of the light emitter 210 is visibly recognizable may be changed as appropriate so as to indicate the position of the fingerprint authentication area 15. If the entire area 212 through which light of the light emitter 210 is visibly recognizable is located within the fingerprint authentication area 15, failure in fingerprint authentication is less liable to occur. If the entire area 212 through which light of the light emitter 210 is visibly recognizable is located within the fingerprint authentication area 15 and the size of the area 212 through which light of the light emitter 210 is visibly recognizable is smaller than the size of the fingerprint authentication area 15, failure in fingerprint authentication is less liable to occur.

In one embodiment, the electronic device 1 comprises a case 2, a display 120 located on at least one surface of the case 2, a fingerprint authentication area 15 located on a surface of the display 120, a light emitter 210 located inside the case 2, and a light guiding unit 17 located inside the case 2. The light guiding unit 17 guides light 211 of the light emitter 210 such that the light 211 passes through the vicinity of the fingerprint authentication area 15.

FIG. 9 illustrates a schematic cross-sectional view showing another example of a cross-section of the electronic device 1 taken along the line A-A′ illustrated in FIG. 1.

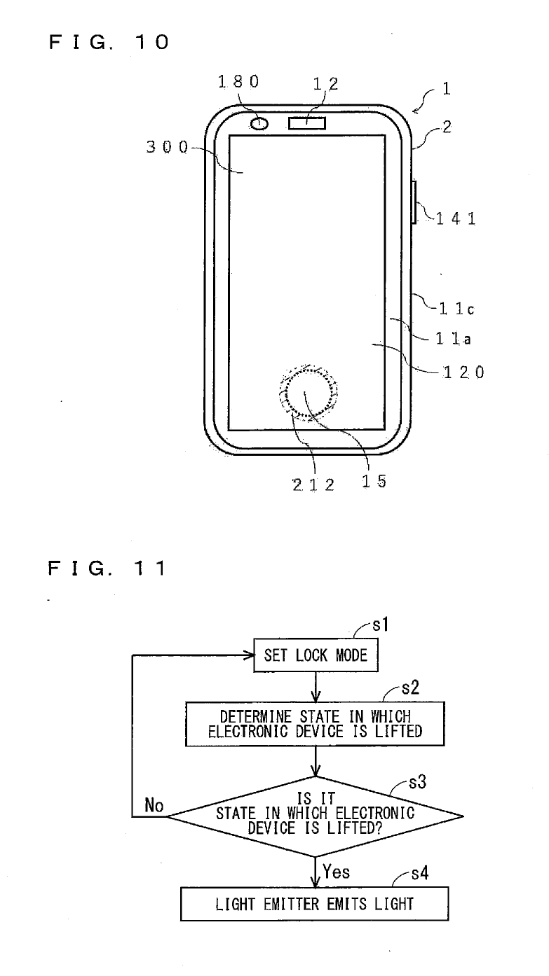

The light guiding unit 17 is not provided at a position on the back that corresponds to a portion around the fingerprint authentication area 15 in order to make light of the light emitter 210 pass through the vicinity of the fingerprint authentication area 15. As the vicinity of the fingerprint authentication area 15, as illustrated in FIG. 10, the electronic device 1 illustrated in FIG. 9 comprises the area 212 through which light of the light emitter 210 is visibly recognizable in the vicinity of the fingerprint authentication area 15. In other words, the electronic device 1 comprises the area 212 surrounding the fingerprint authentication area 15 and through which light of the light emitter 210 is visibly recognizable in the display 120. In one embodiment, light of the light emitter 210 surrounding the fingerprint authentication area 15 does not pass through the inside of the fingerprint authentication area 15 except an outer peripheral portion of the fingerprint authentication area 15. The user can estimate the position of the fingerprint authentication area 15 with the aid of the area 212 through which light of the light emitter 210 is visibly recognizable.

Here, the electronic device 1 illustrated in FIG. 5, FIG. 8, and FIG. 10 may comprise the area 212 through which light of the light emitter 210 is visibly recognizable when the display 120 is displaying an image. Further, the electronic device 1 may comprise the area 212 through which light of the light emitter 210 is visibly recognizable when the display 120 is in the non-display state.

In one embodiment, the controller 100 of the electronic device 1 determines a state of the electronic device 1 based on a detection value of the sensor unit 130, and controls the light emitter 210 based on the determined state of the electronic device 1.

The controller 100 may determine a state of the electronic device 1 based on a detection value of the sensor unit 130. The sensor unit 130 may use the accelerometer 132, for example. The state of the electronic device 1 includes, for example, a state in which the electronic device 1 (i.e., the subject device) is lifted by the user. For example, the controller 100 determines that it is a state in which the electronic device 1 is lifted if a detection value of the accelerometer 132 satisfies a predetermined condition. It is sufficient that acceleration acting on the electronic device 1 when the electronic device 1 is lifted be measured in advance, and the acceleration be stored in the storage 103 in advance as the predetermined condition. Note that a sensor other than the accelerometer 132 may be used as the sensor unit 130 as an auxiliary or an alternative. As the state of the electronic device 1, states other than the state in which the electronic device 1 is lifted may be determined. The states other than the state in which the electronic device 1 is lifted include, for example, a state in which the electronic device 1 is held in a hand of the user and is shook in a predetermined direction.

The controller 100 controls the light emitter 210 based on the determined state of the electronic device 1. For example, if the determined state of the electronic device 1 is a predetermined state, the controller 100 makes the light emitter 210 emit light, or does not make the light emitter 210 emit light.

In one embodiment, the controller 100 of the electronic device 1 determines a state in which the electronic device is lifted as a state of the electronic device 1. If the controller 100 determines that it is a state in which the electronic device is lifted, the controller 100 makes the light emitter 210 emit light.

FIG. 11 illustrates a flowchart showing one example of operation of the electronic device 1 when the electronic device 1 controls the light emitter 210.

In Step s1, the controller 100 sets the electronic device 1 to a lock mode. Note that, when setting the lock mode, the controller 100 may bring the display 120 into a non-display state, or may display a lock screen on the display 120.

In Step s2, the controller 100 determines a state of the electronic device 1 based on a detection value of the accelerometer 132.

In Step s3, if the controller 100 determines that it is a state in which the electronic device 1 is lifted, the processing proceeds to Step s4. If the controller 100 determines that it is not a state in which the electronic device 1 is lifted, the processing returns to Step s1, and the controller 100 maintains the lock mode.

In Step s4, the controller 100 makes the light emitter 210 emit light.

In one embodiment, the electronic device 1 makes the light emitter 210 emit light when it is a state in which the electronic device 1 is lifted. Therefore, the user can easily locate the fingerprint authentication area 15 when there is a high probability of performing fingerprint authentication.

In one embodiment, the controller of the electronic device makes the light emitter 210 emit light if the controller detects operation performed by a finger based on a detection value of the sensor unit 130. The operation performed by a finger may be tap operation.

The controller 100 may detect operation performed by a finger based on a detection value of the sensor unit 130. The sensor unit 130 may use at least one of the accelerometer 132 and the touch sensor 131, for example. The controller 100 makes the light emitter 210 emit light if the controller 100 detects operation performed by a finger.

In one embodiment, the operation performed by a finger is tap operation.

For example, the controller 100 may detect tap operation performed on the electronic device 1 by a finger of the user if the detection value of the accelerometer 132 satisfies a predetermined condition. It is sufficient that acceleration acting on the electronic device 1 when the user taps the electronic device 1 with a finger be measured in advance, and the acceleration be stored in the storage 103 in advance as the predetermined condition. For example, the controller 100 may detect tap operation performed on the electronic device 1 by a finger of the user if a detection value of the touch sensor 131 satisfies a predetermined condition. It is sufficient that change in electrostatic capacitance generated in the touch sensor 131 when the user taps the display 120 with a finger be stored in the storage 103 in advance as the predetermined condition.

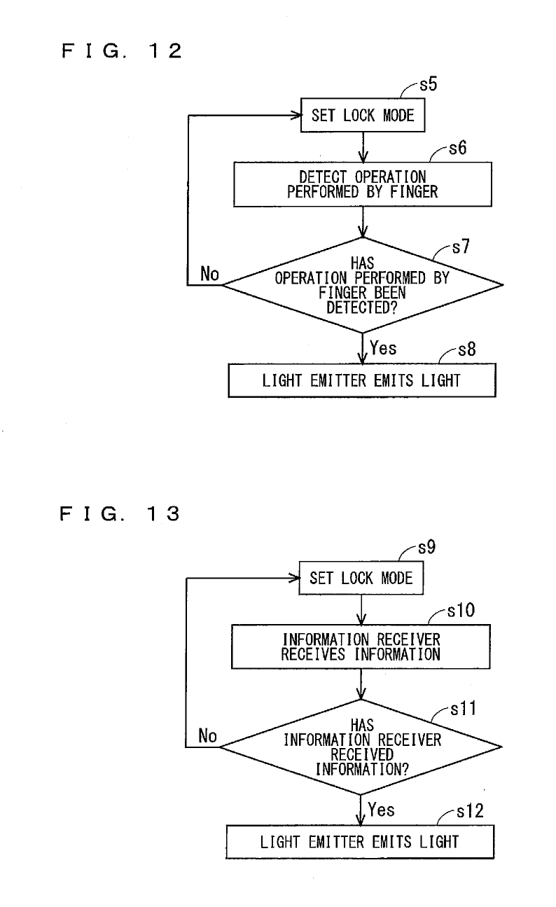

FIG. 12 illustrates a flowchart showing one example of operation of the electronic device 1 when the electronic device 1 makes the light emitter 210 emit light.

In Step s5, the controller 100 sets the electronic device 1 to a lock mode. Note that, when setting the lock mode, the controller 100 may bring the display 120 into a non-display state, or may display a lock screen on the display 120.

In Step s6, the controller 100 detects operation performed by a finger based on a detection value of the sensor unit 130.

In Step s7, if the controller 100 detects operation performed by a finger by using the touch sensor 131 or the accelerometer 132, the processing proceeds to Step s8. If the controller 100 does not detect operation performed by a finger, the processing returns to Step s5, and the controller 100 maintains the lock mode.

In Step s8, the controller 100 makes the light emitter 210 emit light.

According to one embodiment, for example, the user can make the light emitter 210 emit light by tapping the electronic device 1 with a finger. Therefore, the user can easily locate the fingerprint authentication area 15 at the user's discretion.

In one embodiment, the electronic device 1 comprises an information receiver that receives information. If the information receiver receives information, the controller makes the light emitter 210 emit light.

The controller 100 receives information by using the wireless communication unit 110 as the information receiver. The information includes notification information of an application. The notification information of an application includes, for example, notification information of an email application, a phone application, and an application for a social network service (SNS).

The controller 100 makes the light emitter 210 emit light if the information receiver receives information.

FIG. 13 illustrates a flowchart showing one example of operation of the electronic device 1 when the electronic device 1 makes the light emitter 210 emit light.

In Step s9, the controller 100 sets the electronic device 1 to a lock mode. Note that, when setting the lock mode, the controller 100 may bring the display 120 into a non-display state, or may display a lock screen on the display 120.

In Step s10, the controller 100 determines whether or not the information receiver has received information.

In Step s11, if the information receiver receives information, the processing proceeds to Step s12. If the information receiver does not receive information, the processing returns to Step s9, and the controller 100 maintains the lock mode.

In Step s12, the controller 100 makes the light emitter 210 emit light.

In Step s11, if the information receiver does not receive information, the electronic device 1 maintains display of a home screen without making the light emitter 210 emit light.

According to one embodiment, for example, the light emitter 210 emits light when the information receiver receives information. Therefore, the user can easily locate the fingerprint authentication area 15 when there is a high probability of performing fingerprint authentication.

In examples described above, the electronic device 1 is a mobile phone such as a smartphone, but may be an electronic device of other types. The electronic device 1 may be, for example, a tablet terminal, a personal computer, or a wearable device. The wearable device acceptable as the electronic device 1 may be of an arm-worn type such as a wristband type or a wristwatch type, a head-worn type such as a headband type or an eyeglass type, or a body-worn type such as a clothing type.

While the electronic device 1 has been described in detail, the foregoing description is in all aspects illustrative and not restrictive. Further, various examples described above can be applied in combination on the condition that the combination be consistent. It is therefore understood that numerous unillustrated examples can be devised without departing from the scope of the present disclosure.

1. An electronic device comprising:
a case;
a display located on at least one surface of the case;
a fingerprint authentication area located on a surface of the display; and
a light emitter located inside the case, wherein
the fingerprint authentication area comprises an area through which light of the light emitter is visibly recognizable.

2. The electronic device according to claim 1, further comprising
a light guiding unit located inside the case, wherein
the light guiding unit guides the light of the light emitter such that the light passes through the fingerprint authentication area.

3. An electronic device comprising:
a case;
a display located on at least one surface of the case;
a fingerprint authentication area located on a surface of the display;
a light emitter located inside the case; and
a light guiding unit located inside the case, wherein
the light guiding unit guides light of the light emitter such that the light passes through a vicinity of the fingerprint authentication area.

4. The electronic device according to claim 1, further comprising:
a sensor; and
at least one processor.

5. The electronic device according to claim 3, further comprising:
a sensor; and
at least one processor.

6. The electronic device according to claim 4, wherein
the at least one processor determines a state of the electronic device based on a detection value of the sensor, and controls the light emitter based on the state of the electronic device.

7. The electronic device according to claim 5, wherein
the at least one processor determines a state of the electronic device based on a detection value of the sensor, and controls the light emitter based on the state of the electronic device.

8. The electronic device according to claim 6, wherein
the at least one processor determines based on the detection value whether the electronic device is lifted, and makes the light emitter emit light when the at least one processor determines that the electronic device is lifted.

9. The electronic device according to claim 7, wherein
the at least one processor determines based on the detection value whether the electronic device is lifted, and makes the light emitter emit light when the at least one processor determines that the electronic device is lifted.

10. The electronic device according to claim 4, wherein
the at least one processor makes the light emitter emit light when the at least one processor detects operation performed by a finger based on a detection value of the sensor.

11. The electronic device according to claim 5, wherein
the at least one processor makes the light emitter emit light when the at least one processor detects operation performed by a finger based on a detection value of the sensor.

12. The electronic device according to claim 10, wherein
the operation performed by the finger comprises tap operation.

13. The electronic device according to claim 11, wherein
the operation performed by the finger comprises tap operation.

14. The electronic device according to claim 1, further comprising:
at least one processor; and
a receiver configured to receive information, wherein
the at least one processor makes the light emitter emit light when the receiver receives the information.

15. The electronic device according to claim 3, further comprising:
at least one processor; and
a receiver configured to receive information, wherein
the at least one processor makes the light emitter emit light when the receiver receives the information.

16. A control method for an electronic device, the electronic device comprising:
a case;
a display located on at least one surface of the case;
a fingerprint sensor comprising a fingerprint authentication area located on a surface of the display;
a light emitter located inside the case; and
at least one processor,
the fingerprint authentication area comprising an area through which light of the light emitter is visibly recognizable, the control method comprising
determining whether fingerprint authentication of the fingerprint sensor is possible by using the at least one processor, and making the light emitter emit light when it is determined that the fingerprint authentication is possible.

17. A control method for an electronic device, the electronic device comprising:
a case;
a display located on at least one surface of the case;
a fingerprint sensor comprising a fingerprint authentication area located on a surface of the display;
a light emitter located inside the case;
at least one processor; and
a light guiding unit located inside the case,
the light guiding unit guiding light of the light emitter such that the light passes through a vicinity of the fingerprint authentication area, the control method comprising
determining whether fingerprint authentication of the fingerprint sensor is possible by using the at least one processor, and making the light emitter emit light when it is determined that the fingerprint authentication is possible.
